(19) United States
(12) Patent Application Publication
(10) Pub. No.: US 2026/0351986 A1
(43) Pub. Date: Nov. 5, 2026

(54) Topology for a multi-charging apparatus

(71) Applicant: Hilti Aktiengesellschaft, Schaan (LI)

(72) Inventors: Andreas ZAGLER, Odelzhausen (DE); Johannes KERLER, Walkertshofen (DE); Johannes GUGGEMOS, Bad Wörishofen (DE)

(21) Appl. No.: 19/606,804

(22) PCT Filed: Jan. 21, 2025
(86) PCT No.: PCT/EP2025/051356

§ 371 Date: Jul. 16, 2026

(30) Foreign Application Priority Data
Feb. 9, 2024 (EP) 24156764.3

(51) Int. Cl. H02J 7/02

(52) U.S. Cl. CPC H02J 7/02; H02J 2207/20

(57) ABSTRACT

The present invention includes a charging apparatus, in particular for supplying at least a first and second energy storage unit with electrical energy, including a mains power connection for the releasable connection to a mains power source and a control apparatus. The charging apparatus includes a rectifier, a power factor correction filter, a pre-setting apparatus with an isolated DC-DC converter and a capacitor for generating an isolated DC link voltage, and a fine-tuning apparatus with at least a first and second regulated and unisolated DC-DC converter, wherein each DC-DC converter includes an interface device for the releasable connection to an energy storage unit, such that a power value can be provided at the first and/or second interface device, and wherein the power value at the first and/or second interface device corresponds to at least a portion of a total power.

The present invention relates to a charging apparatus, in particular for supplying at least a first and second energy storage unit with electrical energy.

Furthermore, the present invention relates to a system comprising a charging apparatus and at least a first and second energy storage unit which can be connected to the charging.

In addition, the present invention relates to a method for controlling and regulating a system comprising a charging apparatus and at least a first and second energy storage unit which can be connected to the charging apparatus.

### BACKGROUND

Charging apparatuses (also called charger or charging device) for charging rechargeable batteries or other energy storage units are widely known from the prior art. The rechargeable batteries and energy storage units can be used, for example, to supply machine tools (i.e. drills, hammer drills, saws, grinders, lamps or the like). Such charging apparatuses have one or more interface devices, through which rechargeable batteries or other energy storage units can be releasably connected to the charging apparatus and supplied with electrical energy.

### SUMMARY OF THE INVENTION

The charging apparatuses belonging to the prior art often have an excessively complicated or complex and thus excessively expensive design.

It is an object of the present invention to address the problem described above.

The present invention provides a charging apparatus, in particular for supplying at least a first and second energy storage unit with electrical energy, comprising a mains power connection for the releasable connection to a mains power source and a control apparatus.

According to the invention, the charging apparatus comprises
a rectifier;
a power factor correction filter;
a pre-setting apparatus with an isolated DC-DC converter and a capacitor for generating an isolated DC link voltage, and
a fine-tuning apparatus having at least a first and second regulated and unisolated DC-DC converter, wherein each DC-DC converter comprises an interface device for the releasable connection to an energy storage unit, such that a power value can be provided at the first and/or second interface device, and wherein the power value at the first and/or second interface device corresponds to at least a portion of a total power.

The capacitor can also be referred to as a DC link capacitor.

According to a further advantageous embodiment, it may be possible for the pre-setting apparatus to comprise at least one power factor correction filter.

According to an alternative embodiment, it may be possible for the power factor correction filter (PFC filter) and the isolated DC-DC converter to be integrated in a single component.

According to an alternative embodiment, it may be possible for the isolated DC link voltage to correspond to 60 volts or less.

According to an alternative embodiment, it may be possible for at least one filter element to be included.

According to an alternative embodiment, it may be possible for each interface device to comprise at least one transceiver, such that at least one signal can be received from at least a first energy storage unit for the purpose of setting a power value at a first interface device.

According to an alternative embodiment, it may be possible for the energy storage unit to be in the form of a rechargeable battery, in particular for supplying a machine tool with electrical energy.

The present invention further provides a system comprising a charging apparatus and at least a first and second energy storage unit which can be connected to the charging apparatus, wherein the charging apparatus comprises a mains power connection for the releasable connection to a mains power source and a control apparatus.

According to the invention, the charging apparatus comprises a rectifier, a power factor correction filter, a pre-setting apparatus with an isolated DC-DC converter and a capacitor for generating an isolated DC link voltage, and a fine-tuning apparatus with at least a first and second regulated and unisolated DC-DC converter, wherein each DC-DC converter comprises an interface device for the releasable connection to an energy storage unit, such that a power value can be provided at the first and/or second interface device, and wherein the power value at the first and/or second interface device corresponds to at least a portion of a total power.

According to an alternative embodiment, it may be possible for each energy storage unit to respectively comprise a transceiver for at least emitting at least one signal to a transceiver of the control apparatus, and wherein the charging apparatus is configured to provide a voltage value at the at least one interface device according to the signal received by the charging apparatus, wherein the power value corresponds to a portion of the total power.

In addition, the present invention provides a method for controlling and regulating a system comprising a charging apparatus and at least a first and second energy storage unit which can be connected to the charging apparatus, wherein the charging apparatus comprises a mains power connection for the releasable connection to a mains power source and a control apparatus, and wherein the at least first and second energy storage unit each comprise a transceiver for transmitting and receiving signals.

According to the invention, the method comprises the method steps of:
generating an isolated DC link voltage by means of a pre-regulation apparatus comprising an isolated DC-DC converter and a capacitor;
connecting at least one energy storage unit to at least one interface device of the charging apparatus;
emitting at least one signal from the at least one energy storage unit to the charging apparatus; and
providing a power value at the at least one interface device according to the signal received by the charging apparatus, wherein the power value at the at least one interface device corresponds to a portion of the total power.

Further advantages emerge from the following description of the figures. Various exemplary embodiments of the present invention are illustrated in the figures.

The figures, the description and the claims contain numerous features in combination. A person skilled in the art will expediently also consider the features individually and combine them to produce useful further combinations.

### BRIEF DESCRIPTION OF THE DRAWINGS

In the figures:

FIG. 1 shows a schematic side view of a charging apparatus according to one exemplary embodiment having four interface devices and three rechargeable batteries;

FIG. 2 shows a circuit diagram of the subject matter according to the invention according to a first embodiment; and

FIG. 3 shows a circuit diagram of the subject matter according to the invention according to a second embodiment.

### DETAILED DESCRIPTION

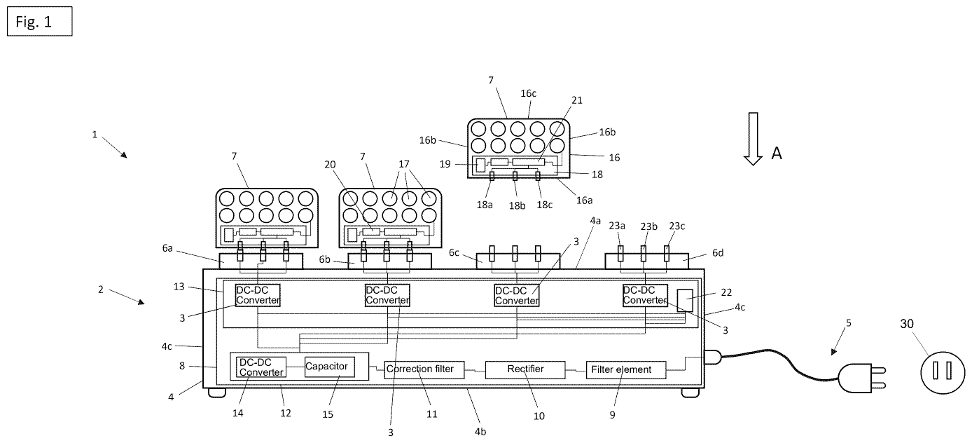

FIG. 1 shows a system 1 consisting of a charging apparatus 2 and a number of energy storage units 3. In the present exemplary embodiment, the energy storage units 3 are in the form of rechargeable batteries. The energy storage units 7 in the form of rechargeable batteries can be used, for example, to supply energy to a machine tool (i.e. a hammer drill, a drill, a saw, a grinder or the like).

The charging apparatus 2 according to a first embodiment essentially comprises a charger housing 4, a mains power connection 5 for the releasable connection to a mains power source 30 (shown solely schematically in the drawings) and four interface devices 6a, 6b, 6c, 6d. The mains power source 30 can also be referred to as a socket.

The charger housing 4 comprises a top side 4a, an underside 4b and four side walls 4c.

Each interface device 6a, 6b, 6c, 6d is used to receive and hold a respective energy storage unit 7, so that the energy storage unit 7 can be supplied with electrical energy by the charging device 2 in a charging operation.

The interface devices 6a, 6b, 6c, 6d are positioned on the top side of the charger housing 4.

Furthermore, each interface device 6a, 6b, 6c, 6d respectively comprises a positive contact 23a, a negative contact 23b and a communication contact 23c.

The mains power connection 5 is in the form of a power cable and is connected to one of the side walls 4c such that electrical energy can reach the charging apparatus 2 through the mains power connection 5. In the present exemplary embodiment, the electrical voltage of the mains power source 30 is 230 V. According to an alternative embodiment, the mains power source 30 can also provide less than 230 V (e.g. 120 V).

FIG. 1 shows the charging apparatus 2 in which two of the four interface devices 6a, 6b, 6c, 6d are connected to a respective energy storage unit 7. A third energy storage unit 7 is brought to a third interface device 6c in the direction A. A fourth interface device 6d is illustrated without an energy storage unit. The energy storage units 7 shown in the figures are substantially identical.

Furthermore, according to the first embodiment, the charging apparatus 2 comprises a control apparatus 8, a filter element 9, a rectifier 10, a power factor correction filter 11, a pre-setting apparatus 12, a transceiver 22 and a fine-tuning apparatus 13.

According to an alternative embodiment, the charging apparatus 2 does not comprise a filter element.

The pre-setting apparatus 12 is essentially used to reduce the voltage value of the mains power source 30 from 230 V to a voltage value of less than 60 volts.

In this case, the pre-setting apparatus 12 essentially comprises an isolated DC-DC converter 14 and a capacitor 15. The isolated DC-DC converter 14 and the capacitor 15 are used to generate a DC link or an isolated DC link voltage. According to the first exemplary embodiment, a DC link voltage of 55 volts is generated by the pre-setting apparatus 12. The present pre-setting apparatus 12 is designed in such a way that a maximum of 59 volts or less can be generated.

The control apparatus 8 is used to control and regulate the different functions of the charging apparatus 2 and its components. The functions include, inter alia, setting or controlling and regulating the output power (also referred to as charging power) to an energy storage unit 7 connected to the charging apparatus 2.

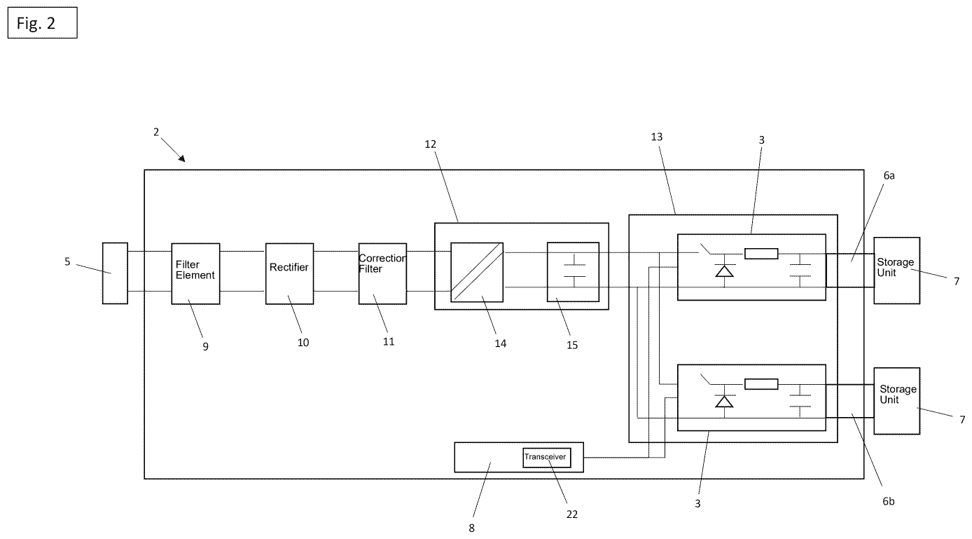

The charging apparatus 2 according to the first embodiment shown in FIGS. 1 and 2 has a power factor correction filter 11 as an independent component that is not part of the pre-setting apparatus 12.

The circuit diagram shown in FIG. 2 has a fine-tuning apparatus 13 with only two unisolated DC-DC converters 3, each of which comprises an interface device 6a, 6b. Alternatively, more than two unisolated DC-DC converters 3, each with an interface device 6a, 6b, 6c, 6d, may also be included.

As already described above, each interface device 6a, 6b, 6c, 6d is used for the releasable connection to a respective energy storage unit 7.

Each DC-DC converter 3 is connected to the control apparatus 8 in such a way that a voltage value and a current intensity value for generating a power value can be provided at an interface device 6a, 6b, 6c, 6d. The power value that can be set or is available at each interface device 6a, 6b, 6c, 6d is a portion of the total power generated in the DC link. For example, it is possible for an equal portion of the total power to be provided at any time at each interface device 6a, 6b, 6c, 6d.

The energy storage unit 7 in the form of a rechargeable battery can be releasably connected to the machine tool, for example, in order to supply the machine tool with electrical energy.

The rechargeable battery 7 essentially comprises a rechargeable battery housing 16, a number of energy storage cells 17, a rechargeable battery interface 18, a transceiver 19, a storage unit 20 and a control device 21.

The energy storage cells 16 can also be referred to as rechargeable battery cells and are arranged in the interior of the rechargeable battery housing 16.

The rechargeable battery housing 16 essentially comprises a cover element 16a, four side walls 16b and a base element 16c.

The rechargeable battery interface 18 is arranged on the outside of the cover element 16a and is used to electrically or electronically as well as mechanically connect the rechargeable battery 7 to the machine tool or the charging apparatus 2.

The transceiver 19 may also be referred to as a transmitting and receiving unit or communication device and is used to transmit and receive electrical signals, whereby data and information can be transmitted from or to the rechargeable battery 7.

For electrical or electronic connection, the rechargeable battery interface 18 has a positive contact 18a, a negative contact 18b and a communication contact 18c.

The positive contact 18a is connected to the positive contact 23a, the negative contact 18b is connected to the negative contact 23b and the communication contact 18c is connected to the communication contact 23c.

The positive and negative contacts 18a, 18b are used to produce a circuit when the rechargeable battery 7 is connected to a machine tool or a charging apparatus 2. The communication contact 18c is connected to the transceiver 19 and is used to transmit and receive data and information in the form of electrical signals. The transceiver 19 is in turn connected to the control device 21.

Alternatively or additionally, the transceiver 19 can also be in the form of a wireless radio communication device (e.g. based on Bluetooth technology).

The energy storage cells 17 are used to receive, store and deliver electrical energy again. The energy storage cells 17 are of cylindrical shape and are based on lithium-ion technology. Each energy storage cell 17 comprises, at one end, a contact device, which serves for the transmission of electrical energy. The individual contact devices are connected via corresponding lines to the control device 21 of the rechargeable battery 7.

As an alternative, the energy storage cells 17 may also be based on another suitable technology.

The cylindrical shape of the energy storage cells 17 is likewise optional, so that any other suitable shape or geometry may also be selected. Therefore, it is in particular also possible for the energy storage cells 17 to be designed as pouch cells.

It is additionally also possible for the rechargeable battery 7 to comprise both cylindrical energy storage cells 17 and pouch cells. It is in particular possible for the rechargeable battery 7 to comprise only a single cylindrical energy storage cell 17 and a single pouch cell.

The control device 21 regulates and controls various functions of the rechargeable battery 7. The functions include, inter alia, controlling the receipt and delivery of electrical energy into and from the energy storage cells 17. Furthermore, the control device 21 is used to control the amount of electrical energy that is to be received or delivered by the energy storage cells 17.

The storage unit 20 is connected to the control device 21 and is used to store and provide data and information. The data and information include, inter alia, threshold values for the voltage and current intensity for a charging and discharging operation of the energy storage unit 7.

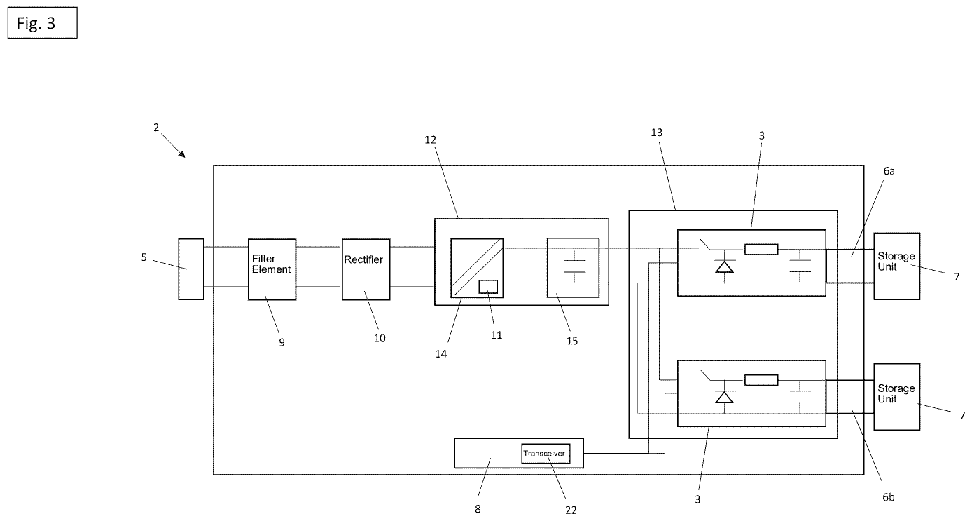

FIG. 3 shows a charging apparatus 2 according to a second embodiment, in which the power factor correction filter 11 is not an independent component, but is formed together with the isolated DC-DC converter 14 in a single component. As a result, the power factor correction filter 11 is a component of the pre-setting apparatus 12.

The circuit diagram shown in FIG. 3 comprises only two interface devices 6a, 6b each with an unisolated DC-DC converter 3.

In order to carry out the method, a mains voltage (e.g. 230 V) is first reduced to a DC link voltage in the DC link by the isolated DC-DC converter 14 and capacitor 15.

A first energy storage unit 7 in the form of a rechargeable battery is connected to the first interface device 6a and a second energy storage unit 7 in the form of a rechargeable battery is connected to the second interface device 6b. By connecting the energy storage units 7 to the respective interface devices 6a, 6b, 6c, 6d, on the one hand, electrical signals can be exchanged between the energy storage unit 7 and the charging apparatus 2. On the other hand, electrical energy can pass from the charging apparatus 2 to the respective energy storage units 7.

When the first energy storage unit 7 is connected to the first interface device 6a, a corresponding signal is transmitted from the transceiver 19 of the first energy storage unit 7 to the transceiver 22 of the charging apparatus 2. The signal reaches the control apparatus 8 of the charging apparatus 2. The received signal is used to transfer the specific parameters for a charging operation of the first energy storage unit 7 to the control apparatus 8. Likewise, a corresponding signal is transmitted from the transceiver 19 of the second energy storage unit 7 to the transceiver 22 of the charging apparatus 2 when the second energy storage unit 7 is connected to the second interface device 6b. This signal also reaches the control apparatus 8 of the charging apparatus 2. The received signal is used to transfer the specific parameters for a charging operation of the second energy storage unit 7 to the control apparatus 8. The parameters include, inter alia, threshold values for the voltage and current intensity for the charging operation.

With the aid of the control apparatus 8, a first power value is set by the first DC-DC converter 3, with the result that a first power for charging the first energy storage unit 7 according to the signal is set at the first interface device 6a.

Furthermore, a second power value is set by the second DC-DC converter 3, with the result that a second power for charging the second energy storage unit 7 according to the signal is set at the second interface device 6b.

The first and second power values each correspond to a portion of the available total power of the charging apparatus 2.

### REFERENCE SIGNS

1 System
2 Charging apparatus
3 Unisolated DC-DC converter
4 Charger housing
5 Mains power connection
6a First interface device
6b Second interface device
6c Third interface device
6d Fourth interface device
7 Energy storage unit
8 Control apparatus of the charging apparatus
9 Filter element
10 Rectifier
11 Power factor correction filter
12 Pre-setting apparatus
13 Fine-tuning apparatus
14 Isolated DC-DC converter
15 Capacitor
16 Rechargeable battery housing
16a Cover element
16b Side walls
16c Base element
17 Energy storage cell
18 Rechargeable battery interface
18a Positive contact of the rechargeable battery interface
18b Negative contact of the rechargeable battery interface
18c Communication contact of the rechargeable battery interface
19 Transceiver of the energy storage unit
20 Storage unit of the energy storage unit
21 Control device
22 Transceiver of the charging apparatus
23a Positive contact of an interface device
23b Negative contact of an interface device
23c Communication contact of an interface device
30 Power source

What is claimed is:

1-10. (canceled)

11: A charging apparatus comprising:
a mains power connection connectable to a mains power source;
a controller;
a rectifier;
a power factor correction filter;
a pre-setter with an isolated DC-DC converter and a capacitor for generating an isolated DC link voltage; and
a fine-tuner having a first and second regulated and unisolated DC-DC converter, each of the first and second regulated and unisolated DC-DC converters including an interface connectable to an energy storage unit, such that a power value is providable at the interface, the power value at the interface corresponding to at least a portion of a total power.

12: The charging apparatus as recited in claim 11, wherein the charging apparatus supplies at least the energy storage unit and a further energy storage unit with electrical energy.

13: The charging apparatus as recited in claim 11, wherein the pre-setter comprises the power factor correction filter.

14: The charging apparatus as recited in claim 13, wherein the power factor correction filter and the isolated DC-DC converter are integrated in a single component.

15: The charging apparatus as recited in claim 11, wherein the isolated DC link voltage corresponds to 60 volts or less.

16: The charging apparatus as recited in claim 11 further comprising a filter.

17: The charging apparatus as recited in claim 11, wherein each interface comprises at least one transceiver, such that at least one signal is receivable from at least the energy storage unit for the purpose of setting the power value at the interface.

18: The charging apparatus as recited in claim 11, wherein the charging apparatus supplies the energy storage unit with electrical energy, the energy storage unit being in the form of a rechargeable battery.

19: The charging apparatus as recited in claim 18, wherein the energy storage unit supplies a machine tool with electrical energy.

20: A system comprising a charging apparatus and a first and second energy storage unit connectable to the charging apparatus, the charging apparatus comprising:
a mains power connection connectable to a mains power source;
a controller;
a rectifier;
a power factor correction filter;
a pre-setter with an isolated DC-DC converter and a capacitor for generating an isolated DC link voltage; and
a fine-tuner with at least a first and second regulated and unisolated DC-DC converter, each of the first and second regulated and unisolated DC-DC converters comprising an interface connectable to an energy storage unit, such that a power value is providable at the interface, the power value at the interface corresponding to at least a portion of a total power.

21: The system as recited in claim 20, wherein each of the first and second energy storage units respectively comprises a transceiver for at least emitting at least one signal to a further transceiver of the control apparatus, the charging apparatus being configured to provide a power value at the interface according to the at least one signal received by the charging apparatus.

22: A method for controlling and regulating a system comprising a charging apparatus and a first and second energy storage unit connectable to the charging apparatus, the charging apparatus comprising a mains power connection connectable to a mains power source and a controller, the first and second energy storage units each comprising a transceiver for transmitting and receiving signals, the method comprising the steps of:
generating an isolated DC link voltage via a pre-regulator comprising an isolated DC-DC converter and a capacitor;
connecting at least one energy storage unit of the first and second energy storage units to at least one interface of the charging apparatus;
emitting at least one signal from the at least one energy storage unit to the charging apparatus; and
providing a power value at the at least one interface according to the at least one signal received by the charging apparatus, the power value at the at least one interface corresponding to a portion of the total power.
